(19) United States
(12) Patent Application Publication
(10) Pub. No.: US 2021/0317305 A1
(43) Pub. Date: Oct. 14, 2021

(54) (PER)FLUOROPOLYETHER DERIVATIVES

(71) Applicant: SOLVAY SPECIALTY POLYMERS ITALY S.P.A., Bollate (IT)

(72) Inventors: Roberto VALSECCHI, Brembate (IT); Rosaldo PICOZZI, Cesate (IT)

(21) Appl. No.: 17/264,953

(22) PCT Filed: Aug. 1, 2019
(86) PCT No.: PCT/EP2019/070776

§ 371 Date: Feb. 1, 2021

(30) Foreign Application Priority Data
Aug. 3, 2018 (EP) 18187172.4

(51) Int. Cl. C08L 71/08; C08G 65/48

(52) U.S. Cl. CPC C08L 71/08; C08G 2650/64; C08G 2650/48; C08G 65/48

(57) ABSTRACT

The present invention relates to novel (per)fluoropolyether (PFPE) polymer derivatives, a method for their manufacture and their use as intermediates for the synthesis of a variety of functional derivatives, including notably silane-group containing derivatives.

### CROSS-REFERENCE TO RELATED APPLICATIONS

This application claims priority from EP No. 18187172.4. filed on 3 Aug. 2018, the whole content of this application being incorporated herein by reference for all purposes.

### TECHNICAL FIELD

The present invention relates to novel (per)fluoropolyether (PFPE) polymer derivatives having high thermal, chemical and hydrolytic stability, a method for their manufacture and their use as intermediates for the synthesis of a variety of functional derivatives, including notably silane group-containing derivatives.

### BACKGROUND ART

Various families of (per)fluoropolyethers are known, which are obtained for example by oxidation of (per)fluoroolefins, such as tetrafluoroethylene and hexafluoropropylene, with oxygen, under the action of ultraviolet radiation, and/or by anionic polymerization, possibly under fluoride catalysis, of (per)fluoroolefin oxides, including hexafluoropropylene oxide.

Functional derivatives thereof, possessing reactive end groups at the ends of the (per)fluoropolyether chain, are also well known in the art since a long time, and have found usefulness in the manufacture of a large variety of derivatives and polymers adapted to cope with high demanding applications, such as, notably, harsh chemical envoronments, high temperatures, etc.

Among derivatives which have been disclosed in the art, mention can be made of (per)fluoropolyether derivatives possessing chain ends including ethylenically unsaturated double bonds, which have been notably used for being incorporated in polyaddition polymers and/or as intermediate for the manufacture of other derivatives, including those comprising silane groups.

For instance, US 2003/0139620 (Shin-Etsu Chemical Co. , Ltd.) discloses an example of perfluoropolyether derivatives having ethylenically unsaturated double bonds, said derivative having formula:

R_{f}[CH₂)ₙ—O—(CH₂)ₘCH═CH₂]₂

wherein Rf is a divalent straight-chain perfluoropolyether radical with n and m being integers ≥0 and equal to or different from each other.

The ethylenically unsaturated double bond(s) present as end groups in said (per)fluoropolyether derivatives can be further reacted for providing a variety of derivatives, which may find utility as additives notably in coating compositions and/or in lubricating formulations.

EP 2915833 (Daikin Industries, Ltd.) discloses perfluoro(poly)ether group containing silane compounds, represented by formula (1a) or (1b):

A-Rf—X—SiQₖY₃₋ₖ (1a)

Y₃₋ₖQₖSi—X—RF—X—SiQₖY₃₋ₖ (1b)

It is worth noting that in the above mentioned formulae, linking group —X— is a divalent organic group, which can be selected among a very long list of alternative meanings. Examples 2 to 15 of EP 2915833 disclose the synthesis of polymers having, as the linking group between the perfluoropolyether chain and the silane-containing group, a hydrocarbon moiety always containing one oxygen atom (i.e., chain complying with formula —CH₂OCH₂CH₂CH₂—). Only Example 1 discloses the synthesis of a perfluoropolyether polymer comprising a divalent alkylene chain as the —X— group, notably of formula —CH₂CH₂CH₂CH₂— Nevertheless, in compounds taught in the prior art, the ethylenically unsaturated double bond is actually connected to the (per)fluoropolyoxyalkylene chain through an ethereal oxygen atom, which connects the terminal —CF₂— moiety of said chain to the double bond-containing moiety, in generally through a —CH₂—O—CH₂— moiety.

While ethereal bonds among alkylene groups are generally considered sufficiently stable for withstanding different chemical environments, and for remaining unreacted under several organic chemistry reactions, in (per)fluoropolyether derivatives, as mentioned above, the presence of vicinal (per)fluorinated groups may have a detrimental effect on the stability of the said moiety, which remains, all in all, a weak point in the otherwise robust, and chemically, hydrolytically and thermally stable (per)fluoropolyether structure.

The need is therefore felt to provide novel (per)fluoropolyether derivatives comprising one or more than one reactive chain end under the form of an ethylenically unsaturated double bond, said reactive chain end(s) being bound to the backbone of the (per)fluoropolyoxyalkylene chain through a thermally, hydrolytically and chemically stable bridging group.

### SUMMARY OF INVENTION

The aim of the present invention is to overcome the aforementioned drawbacks of the (per)fluoropolyether derivatives of the prior art. More in particular, the aim of the present invention is to provide (per)fluoropolyether derivatives comprising one or more than one reactive chain end under the form of an ethylenically unsaturated double bond, said reactive chain end(s) being bound to the backbone of the (per)fluoropolyoxyalkylene chain through a thermally, hydrolytically and chemically stable bridging group.

In a first aspect, the present invention relates to a polymer (P) of formula (1a) or (1b) according to present claim 1. The Applicant has surprisingly found that polymer (P) has increased thermal, hydrolytical and chemical stability, both in neutral and basic conditions, when compared to the (per)fluoropolyether derivatives of the prior art having alkenyl moiety(ies) linked to the polymer chain through an ethereal bridging group.

In a second aspect, the present invention relates to a method for manufacturing the polymer (P) of formula (1a) or (1b).

In a third aspect, the present invention pertains to a process for the synthesis of a (per)fluoropolyether derivative comprising reacting at least one polymer (P) of any of formulae (1a) and (1b) with at least one compound possessing reactivity towards an ethylenically unsaturated double bond. The present invention notably pertains to a process for the synthesis of a (per)fluoropolyether derivative comprising at least one silane-containing chain end by reacting at least one polymer (P) with at least one hydrosilane.

In a fourth aspect, the present invention relates to a (per)fluoropolyether group containing-silane compound of formula (6a) or (6b) according to the claims.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural form, depending on the context;
the term “(per)fluoropolyether” is intended to indicate fully or partially fluorinated polyether polymer;
the expression “hydrocarbon group” is intended to denote a group consisting solely of one or more than one carbon atom and a number of hydrogen atoms saturating all free valences of the said carbon atom(s).

As said, in a first aspect, the present invention is directed to a (per)fluoropolyether derivative comprising at least one ethylenically unsaturated double bond and complying with any of formulae (1a) or (1b) [polymer (P) herein below]:

B-R_{f}—(CFX^{F})ₘ—(CR^{H1}R^{H2})ₙ-A (1a)

A-(CR^{H1}R^{H2})ₙ—R_{f}—(CFX^{F})ₘ—(CR^{H1}R^{H2})ₙ-A (1b),

wherein:
A is a hydrocarbon group comprising an ethylenically unsaturated double bond;
B is a group of formula Y—CF₂—O—, wherein Y is selected from the group consisting of F, Cl, and a C₁—C₃ perfluoroalkyl group, preferably a —CF₃;
m is an integer different from zero, preferably m is 1 or 2, more preferably m is 1;
n is an integer different from zero, preferably n is 1 or 2, more preferably n is 1;
each of X^{F}, equal to or different from each other at each occurrence, is independently selected from the group consisting of F and a C₁-C₃ perfluoroalkyl group, preferably a —CF₃; preferably X^{F} is F;
each of R^{H1} and R^{H2}, equal to or different from each other at each occurrence, is independently selected from the group consisting of H and a C₁-C₃ fluorine-free alkyl group; —R_{f} is a fluoropolyoxyalkylene chain [chain (R_{f}) herein below], i.e. a chain comprising a plurality of fluorocarbon segments connected via ethereal bonds.

Chain (R_{f}) of polymer (P) preferably comprises, more preferably consists of, repeating units and said repeating units are independently selected from the group consisting of:

(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}—T, wherein R_{(f-a)} is a fluoropolyoxyalkylene chain comprising a number of repeating units from 0 to 10, said recurring units being chosen among the following : —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

Preferably, chain (R_{f}) complies with the following formula:

[(CFX¹O)_{g1}(CFX²CFX³O)_{g2}(CF₂CF₂CF₂O)_{g3}(CF₂CF₂CF₂CF₂O)_{g4}]— (R_{f}—I)

wherein
X¹ is independently selected from —F and —CF₃,
X², X³, equal or different from each other and at each occurrence, are independently —F, —CF₃, with the proviso that at least one of X is —F;
g1, g2 , g3, and g4, equal or different from each other, are independently integers ≥0, such that g1+g2+g3+g4 is in the range from 2 to 300, preferably from 2 to 100; should at least two of g1, g2, g3 and g4 be different from zero.

More preferably, chain (R_{f}) is selected from chains of formula:

—[(CF₂CF₂O)ₐ₁(CF₂O)ₐ₂]— (R_{f}—IIA)

wherein:
a1 and a2 are independently integers 0 such that the number average molecular weight is between 400 and 10,000, preferably between 2,000 and 8,000; both al and a2 are preferably different from zero, with the ratio a1/a2 being preferably comprised between 0.1 and 10;

—[(CF₂CF₂CF₂O)_{b}]— (R_{f}—IIB)

wherein:
b is an integer >0 such that the number average molecular weight is between 400 and 10,000, preferably between 2,000 and 8,000;

—[(CF₂CF₂CF₂CF₂O)_{c}]— (R_{f}—IIC)

wherein:
c is an integer >0 such that the number average molecular weight is between 400 and 10,000, preferably between 2,000 and 8,000;

—[(CF₂CF₂O)_{d1}(CF₂O)_{d2}(CF(CF₃)O)_{d3}(CF₂CF(CF₃)O)_{d4}]— (R_{f}—IID)

wherein:
d1, d2, d3, d4, are independently integers 0 such that the number average molecular weight is between 400 and 10,000, preferably between 2,000 and 8,000; preferably d1 is 0, d2, d3, d4 are >0, with the ratio d4/(d2+d3) being 1;

—[(CF₂CF₂O)ₑ₁(CF₂O)ₑ₂(CF₂(CF₂)_{ew}CF₂O)ₑ₃]— (R_{f}—IIE)

wherein:
ew=1 or 2;
e1, e2, and e3 are independently integers 0 chosen so that the number average molecular weight is between 400 and 10,000, preferably between 2,000 and 8,000; preferably e1, e2 and e3 are all >0, with the ratio e3/(e1+e2) being generally lower than 0.2;

—[(CF(CF₃)CF₂O)_{f}]— (R_{f}—IIF)

wherein:
f is an integer >0 such that the number average molecular weight is between 400 and 10,000, preferably between 2,000 and 8,000.

Chains (R_{f}-IIA), (R_{f}-IIB), (R_{f}-IIC) and (R_{f}-IIE) are particularly preferred.

Still more preferably, chain (R_{f}) complies with formula (R_{f}-IIA), wherein:
a1, and a2 are integers >0 such that the number average molecular weight is between 400 and 10,000, preferably between 2,000 and 8,000, with the ratio al/a2 being generally comprised between 0.1 and 10, more preferably between 0.2 and 5.

As said, A is a hydrocarbon group comprising an ethylenically unsaturated double bond. While A may comprise one or more than one ethylenically unsaturated double bonds, it is generally preferred for A to be a hydrocarbon group comprising solely one ethylenically unsaturated double bond. Besides said ethylenically unsaturated double bond, group A may include other hydrocarbon moieties, such as alkylene groups, arylene groups, and the like. Nonetheless, it is generally preferred for group A to be a group of formula —(CR^{H3}R^{H4})ₙₐ—CR^{H5}═CR^{H6}R^{H7}, wherein:
each of R^{H3}, R^{H4}, R^{H5}, R^{H6} and R^{H7}, equal to or different from each other at each occurrence, is independently selected from the group consisting of H and a C₁-C₃ fluorine-free alkyl group; preferably each of R^{H3}, R^{H4}, R^{H5}, R^{H6} and R^{H7} is H; and
na is zero or an integer (preferably an integer of 1 to 3), and more preferably na is zero or 1.

In a preferred embodiment, A is a vinyl moiety —CH═CH₂. In another preferred embodiment, A is an allyl moiety —CH₂—CH═CH₂.

The polymer P of formula (1a) above, which contains a single ethylenically unsaturated double bond-containing group A, is also referred to as “monofunctional polymer P”.

The polymer P of formula (1b) above, which contains two ethylenically unsaturated double bond-containing groups A, is also referred to as “bifunctional polymer P”.

In the above formulae, the group —(CR^{H1}R^{H2})ₙ— is recognized to be a linker which connects the group A with the polymer backbone, namely with the monovalent fragment [B-R_{f}—(CFX^{F})ₘ]— of the monofunctional polymer P or the divalent fragment —[R_{f}—(CFX^{F})ₘ]— of the bifunctional polymer P.

Without being bound by any theory, the Applicant believes that the increased stability shown by polymer P is due to the presence of a C—C bond between the group A and the —(CR^{H1}R^{H2})ₙ— group, which is more stable from a thermal, hydrolytic and chemical standpoint than an ethereal bond. This will be more evident from the Examples contained in the following Experimental Section.

According to another aspect, the present invention provides a process for the manufacture of polymer P starting from PFPE halides.

The monofunctional polymer P of formula (1a) is preferably prepared starting from monofunctional PFPE halides of formula (2a), i.e. PFPE comprising a halogen at one polymer end only:

B-R_{f}—(CFX^{F})ₘ—(CR^{H1}R^{H2})ₙ-Ha¹ (2a)

The bifunctional polymer P of formula (1b) is preferably prepared starting from bifunctional PFPE halides of formula (2b), i.e. PFPE comprising a halogen at both polymer ends:

Ha¹-(CR^{H1}R^{H2})ₙ—R_{f}—(CFX^{F})ₘ—(CR^{H1}R^{H2})ₙ-Ha¹ (2b)

In the above formulae (2a) and (2b), Ha¹ is a halogen and B, m, n, X^{F}, R^{H1}, RH² and R_{f} are as defined above.

The process according to the invention comprises reacting the PFPE-halide of formula (2a) or (2b) as defined above with a Grignard reagent of formula A-MgHa², wherein Ha² is a halogen chosen among bromine, iodine and chlorine and A is as defined above.

Preferably, said Grignard reagent has the following formula:

Ha²Mg—(CR^{H3}R^{H4})ₙₐ—CR^{H5}═CR^{H6}R^{H7},

wherein R^{H3}, R^{H4}, R^{H5}, R^{H6}, R^{H7}, Ha² and na are as defined above.

More preferably, said Grignard reagent is selected from allylmagnesium halide and vinylmagnesium halide, preferably from allylmagnesium bromide BrMg—CH₂—CH═CH₂ and vinylmagnesium bromide BrMg—CH═CH₂.

Preferably, the reaction between the PFPE-halide of formula (2a) or (2b) and the Grignard reagent is performed under heating, more preferably at a temperature of about 50° C.

According to a preferred embodiment of the invention, said PFPE-halide is obtained by:

(I) reacting a PFPE-alcohol of formula (3a) or (3b):

B-R_{f}—(CFX^{F})ₘ—(CR^{H1}R^{H2})ₙ—OH (3a)

HO—(CR^{H1}R^{H2})ₙ—R_{f}—(CFX^{F})ₘ—(CR^{H1}R^{H2})ₙ—OH (3b)

with a compound [compound (O) hereinafter] comprising a sulfonyl fluoride moiety, obtaining a PFPE-sulfonate, and
(II) reacting the PFPE-sulfonate obtained in step (I) above with a compound [compound (Q) hereinafter] which is a source of nucleophilic halides, obtaining said PFPE-halide.

Suitable PFPE-alcohol(s) can be obtained according to methods known in the art and are commercially available, for example from Solvay Specialty Polymers Italy S.p.A. under the trade name Fomblin®.

The compound (O) used in the above step (I) is preferably selected from the perfluoroalkanesulfonyl fluorides. Good results have been obtained using the perfluorobutanesulfonyl fluoride as compound (O).

Step (I) is advantageously performed in the presence of a base, such as triethylamine.

Preferably, said step (I) is performed in the presence of an aprotic solvent, such as 1,3-bis(trifluoromethyl)benzene

Preferably, said step (I) is performed under heating, more preferably at a temperature of about 50° C.

The compound (Q) used in the above step (II) is preferably lithium bromide.

Preferably, said step (II) is performed in the presence of an aprotic solvent, such as sulfolane.

Preferably, said step (II) is performed under heating, more preferably up to a temperature of about 200° C.

According to another aspect, the present invention provides methods for the synthesis of (per)fluoropolyether derivatives by conversion of the ethylenically unsaturated double bond of polymer (P) of formula (1a) or (1b) into different moieties, for example an epoxide, a vicinal diol, a vicinal dibromide, a carboxylic acid, an aldehyde and alkyl substituted saturated groups.

According to a first embodiment, an epoxide moiety is obtained by reacting the polymer (P) with peroxides, such as hydrogen peroxide, or peracids.

According to a second embodiment, a vicinal diol moiety is obtained by reacting the polymer (P) with OsO₄ providing a complex and then subjecting said complex to hydrolysis. In an alternative embodiment, the vicinal diol is obtained by hydrolysis of the epoxide obtained by reacting polymer (P) with peroxides or peracids, as disclosed above.

In a third embodiment, a vicinal dibromide moiety is obtained by reacting the polymer (P) with elemental bromine.

In a forth embodiment, a carboxylic acid moiety is obtained by reacting the polymer (P) with an oxidizing agent, such as potassium permanganate.

In a fifth embodiment, an aldehyde moiety is obtained by subjecting the polymer (P) to hydroformylation in the presence of carbon monoxide and hydrogen under pressure and in the presence of a suitable catalyst, such as a transition metal complex.

In a sixth embodiment, an alkyl substituted saturated group is obtained by reacting the polymer (P) with radical species (i.e. by radical addition reaction), optionally in the presence of olefins which can propagate the radical chain.

In another embodiment, a monofunctional silane group is obtained by reacting the polymer (P) with a hydrosilane having at least one hydrolysable radical.

According to a further embodiment, the present invention provides a process for the synthesis of a (per)fluoropolyether derivative of formula (4a) or (4b) comprising at least one silane-containing chain end:

B-R_{f}—(CFX^{F})ₘ—(CR^{H1}R^{H2})ₙ-A*-SiM₃ (4a)

M₃Si-A*—(CR^{H1}R^{H2})ₙ—R_{f}—(CFX^{F})ₘ—(CR^{H1}R^{H2})ₙ-A*-SiM₃ (4b)

by reacting the polymer (P) of formula (1a) or (1b) with HSiM₃, wherein A* is a hydrocarbon group and M is independently halogen or C₁₋₆-alkoxy.

Preferably, said process further comprises:
reacting the derivative of formula (4a) or (4b) with a Grignard reagent of formula Ha²—Mg—M*—CH═CH₂, wherein Ha² is a halogen chosen among bromine, iodine and chlorine and M* is a bond or a divalent organic group, and optionally with a compound of formula KₕL wherein K is a hydroxyl group, a hydrolysable group, or a hydrocarbon group, L is a group which is able to bind to K and h is an integer of 1-3, thus obtaining a compound of formula (5a) or (5b):

B-R_{f}—(CFX^{F})ₘ—(CR^{H1}R^{H2})ₙ-A*-Si(K_{3-k′})(—M*—CH═CH2)_{k′} (5a)

(H₂C═CH—M*—)_{k′}(K_{3-k′})Si-A*-(CR^{H1}R^{H2})ₙ—R_{f}—(CFX^{F})ₘ—(CR^{H1}R^{H2})ₙ-A*-Si(K_{3-k′}) (—M*—CH═CH₂)_{k′} (5b),

wherein k′ is independently 2 or 3;
reacting the compound of formula (5a) or (5b) with HSiM₃, wherein M is as defined above, and optionally with a compound of formula R¹_{h*}L′, wherein R¹ is a hydroxyl group or a hydrolysable group, L′ is a group which is able to bind to R¹ and h* is an integer of 1-3, and/or with a compound of formula R^{2′}_{h**}L″, wherein R^{2′} is C₁₋₂₂-alkyl, L″ is a group which is able to bind to R² and h** is an integer of 1-3, thus obtaining a compound of formula (6a) or (6b):

B-R_{f}—(CFX^{F})ₘ—(CR^{H1}R^{H2})ₙ-A*-SiJₖK₃₋ₖ (6a)

SiJₖR₃₋ₖ-A*-(CR^{H1}R^{H2})ₙ—R_{f}—(CFX^{F})ₘ—(CR^{H1}R^{H2})ₙ-A*-SiJₖK₃₋ₖ (6b)

wherein:
k is independently 2 or 3, and
J represents, each independently at each occurrence, -J*-SiR¹_{n*}R²_{3-n*},
wherein:
J* is a divalent organic group, preferably with the proviso that J* is not a group which forms a siloxane bond together with a Si atom;
R¹ represents, each independently at each occurrence, a hydroxyl group or a hydrolysable group;
R² represents, each independently at each occurrence, a C₁₋₂₂ alkyl group or J′, wherein J′ has the same definition as that of J,
n* is an integer selected from 0 to 3, and the total sum of n* is 1 or more.

According to a further aspect, the present invention relates to a (per)fluoropolyether group containing-silane compound of formula (6a) or (6b):

B-R_{f}—(CFX^{F})ₘ—(CR^{H1}R^{H2})ₙ-A*-SiJₖK₃₋ₖ (6a)

SiJₖR₃₋ₖ-A*-(CR^{H1}R^{H2})ₙ—R_{f}—(CFX^{F})ₘ—(CR^{H1}R^{H2})ₙ-A*-SiJₖK₃₋ₖ (6b)

wherein:
A* is a hydrocarbon group;
B is a group of formula Y—CF₂—O—, wherein Y is selected from the group consisting of F, Cl, and a C₁-C₃ perfluoroalkyl group, said perfluoroalkyl group being preferably —CF₃;
m is an integer different from zero, preferably m is 1 or 2, more preferably m is 1;
n is an integer different from zero, preferably n is 1 or 2, more preferably n is 1;
each of X^{F}, equal to or different from each other at each occurrence, is independently selected from the group consisting of F and a C₁-C₃ perfluoroalkyl group, said perfluoroalkyl group being preferably —CF₃; preferably X^{F} is F;
each of R^{H1} and R^{H2}, equal to or different from each other at each occurrence, is independently selected from the group consisting of H and a C₁-C₃ fluorine-free alkyl group;
R_{f} is a fluoropolyoxyalkylene chain [chain (R_{f})];
K represents, each independently at each occurrence, a hydroxyl group, a hydrolysable group, or a hydrocarbon group;
J represents, each independently at each occurrence, -J*-SiR¹_{n*}R²_{3-n*}, wherein:
J* is a divalent organic group, preferably with the proviso that J* is not a group which forms a siloxane bond together with a Si atom;
R¹ represents, each independently at each occurrence, a hydroxyl group or a hydrolysable group;
R² represents, each independently at each occurrence, a C₁₋₂₂ alkyl group or J′, wherein J′ has the same definition as that of J,
n* is an integer selected from 0 to 3, and the total sum of n* is 1 or more;
k is independently 2 or 3.

Preferably, A* is a group of formula: —(CR^{H3}R^{H4})ₙₐ—CHR^{H5}CR^{H6}R^{H7}—,

wherein:
each of R^{H3}, R^{H4}, R^{H5}, R^{H6}, and R^{H7}, equal to or different from each other at each occurrence, is independently selected from the group consisting of H and a C₁-C₃ fluorine-free alkyl group, preferably each of R^{H3}, R^{H4}, R^{H5}, R^{H6}, and R^{H7} is H, and
na is an integer 0, preferably na is not higher than 3, more preferably na is 0 or 1,

Preferably, A* is —CH₂CH₂— or —CH₂CH₂CH₂—.

Illustrative examples of suitable hydrolyzable groups include alkoxy radicals such as methoxy, ethoxy, propoxy and butoxy, alkoxyalkoxy radicals such as methoxymethoxy and methoxyethoxy, acyloxy radicals such as acetoxy, alkenyloxy radicals such as isopropenoxy, and halogen radicals such as chloro, bromo and iodo. Of these, organooxy radicals such as alkoxy and alkenyloxy radicals and chloro are preferred, with methoxy, ethoxy, isopropenoxy and chloro being most preferred.

Should the disclosure of any patents, patent applications, and publications which are incorporated herein by reference conflict with the description of the present application to the extent that it may render a term unclear, the present description shall take precedence.

The invention will be hereinafter illustrated in greater detail by means of the Examples contained in the following Experimental Section; the Examples are merely illustrative and are by no means to be interpreted as limiting the scope of the invention.

### EXPERIMENTAL SECTION

### Materials

Perfluoro-1-butanesulfonyl fluoride, triethylamine, lithium bromide, allylmagnesium bromide solution 1M in diethylether, allyl iodide, potassium tert-butoxide, tert-butanol, HCl (37% aqueous solution), methanol, 2-methyl-1-propanol and sulfolane were purchased from Sigma Aldrich.

1,3-bis(trifluoromethyl)benzene was obtained from Miteni S.p.A. ZMF-402: CF₃O(CF₂CF₂O)ₚ(CF₂O)_{q}CF₂CH₂OH (p/q=1.0, F=1.07, EW=4570) is available from Solvay Specialty Polymers S.p.A.

### Methods

### NMR

¹H-NMR and ¹⁹F-NMR were recorded on an Agilent System 500 operating at 499.86 MHz for ¹H and 470.30 MHz for ¹⁹F.

### Determination of the Average Functionality

The average functionality (F):

F=2*E_{f}/(E_{f}+Eₙ)

wherein E_{f} is the number of functional end groups and Eₙ is the number of non-functional end groups,
was determined by means of ¹H-NMR and ¹⁹F-NMR according to known methods, for example as disclosed in U.S. Pat. No. 5,919,641.

### Thermal Stability in Neutral Conditions

Thermal stability tests in neutral conditions were carried out according to the following procedure: 50 g of product were charged into a round bottom flask equipped with a mechanical stirrer, a refrigeration column, a precision seal septum and a thermometer; the product was heated to a temperature of 150° C. for 24 hours; a sample of the product was taken out every 8 hours and analysed by ¹H-NMR and ¹⁹F-NMR.

### Thermal Stability in Basic Conditions

Thermal stability tests in basic conditions were carried out according to the following procedure: 50 g of product and dried KOH powder (1.5 molar ratio) were charged into a round bottom flask equipped with a mechanical stirrer, a refrigeration column, a precision seal septum and a thermometer; the mixture was heated to a temperature of 100° C. for 24 hours; a sample of the product was taken out every 8 hours, washed with an aqueous solution of hydrochloric acid (5% w/w) and added with 1,3-bis(trifluoromethyl)benzene. The lower fluorinated phase was separated, dried under vacuum and the recovered residue was analysed by ¹H-NMR and ¹⁹F-NMR.

In the above tests, the percentage of degraded product was monitored by determining the relative ratios of the formed byproducts and the product submitted to the stability test.

### SYNTHESIS EXAMPLES

### Example 1 Synthesis of Polymer P having the Following Formula

CF₃O(CF₂CF₂)ₚ(CF₂)_{q}CF₂13 CH₂CH₂CH═CH₂

### STEP 1: Synthesis of PFPE-Intermediate A having the Formula

CF₃O(CF₂CF₂)ₚ(CF₂O)_{q}CF₂—CH₂O—S(O)₂CF₂CF₂CF₂CF₃

125 g of 1,3-bis(trifluoromethyl)benzene, 17.2 g of perfluoro-1-butanesulfonyl fluoride (57 mmol) and 6.2 g of triethylamine (61 mmol) were charged under inert atmosphere into a 500-ml round bottom flask equipped with a mechanical stirrer, a thermometer, a dropping funnel and a refrigeration column and the temperature was raised up to 50° C.

Then, 200 g of ZMF 402 PFPE of formula CF₃O(CF₂CF₂)ₚ(CF₂)_{q}CF₂CH₂OH (p/q=1.0, F=1.07, EW=4570, 44 meq) were slowly added. The reaction mixture was let under stirring for 3 hours until the signals of the pre-terminal —CF₂ group shifted from −81.3 and −83.3 ppm (when linked to —CH₂OH) to −78.7 and −80.5 ppm (when linked to CH₂O—S(O)₂CF₂CF₂CF₂CF₃). Said shifting was monitored by ¹⁹F-NMR analysis.

At the end of the reaction, the reaction mixture was cooled to 20° C. and the lower fluorinated phase was separated and washed with 50 g of methanol and 80 g of an aqueous solution of hydrochloric acid (5% w/w).

The heavier fluorinated phase was dried under vacuum leaving 197.0 g of the PFPE-Intermediate A having the following formula CF₃O(CF₂CF₂O)ₚ(CF₂O)_{q}CF₂—CH₂O—S(O)₂CF₂CF₂CF₂CF₃ that was confirmed by ¹⁹F-NMR analysis.

### STEP 2: Synthesis of the PFPE-Intermediate B having the Formula

CF₃O(CF₂CF₂O)ₚ(CF₂O)_{q}CF₂CH₂Br

5.7 g of dried lithium bromide, 90 g of sulfolane and 160 g of the PFPE-Intermediate A (p/q=1.0, F=1.07, EW=4845, 33 meq) were charged under inert atmosphere into a 250-ml round bottom flask equipped with a mechanical stirrer, a thermometer and a refrigeration column.

The so obtained reaction mixture was gradually heated up to a temperature of 190° C. and let under stirring for 8 hours until the signals of the pre-terminal —CF₂ group shifted from 78.7 and −80.5 ppm (when linked to —CH₂O—S(O)₂CF₂CF₂CF₂CF₃) to −72.9 and −74.7 ppm (when linked to —CH₂Br). Said shifting was monitored by ¹⁹F-NMR analysis.

Then, the reaction mixture was cooled to 20° C.

Then, 90 g of an aqueous solution of hydrochloric acid (5% w/w), 80 g of 1,3-bis(trifluoromethyl) benzene and 40 g of 2-methyl-1-propanol were added and the mixture was let under stirring for 15 minutes.

The lower fluorinated phase was separated and the solvents were removed by distillation under reduced pressure (T=80° C., P=2 Pa). PFPE-Intermediate B having the formula CF₃O(CF₂CF₂O)ₚ(CF₂O)_{q}CF₂CH₂Br was recovered in an amount of 145 g. The chemical structure was confirmed by ¹⁹F-NMR and ¹H-NMR analyses.

### STEP 3: Synthesis of the Polymer P having the Formula

CF₃O(CF₂CF₂O)ₚ(CF₂O)_{q}CF₂—CH₂CH₂CH═CH2

125 g the PFPE-Intermediate B (p/q=1.0, F=1.07, EW=4617, 27 meq) were charged under inert atmosphere into a 250-ml round bottom flask equipped with a magnetic stirrer bar, a thermometer, a refrigeration column and a dropping funnel.

The temperature of the so obtained reaction mixture was then raised up to 50° C. and 55 ml of allylmagnesium bromide solution 1 M in diethylether were slowly added. The so obtained solution was kept under stirring at reflux for 15 hours until the signals of the pre-terminal —CF₂ group shifted from −72.9 and −74.7 ppm (when linked to —CH₂Br) to −70.4 and −72.6 ppm (when linked to the hydrogenated alkenyl group). Said shifting was monitored by ¹⁹F-NMR analysis.

Then, the reaction mixture was cooled to 20° C. and 80 ml of deionized water were slowly added. The so obtained solution was then kept under vigorous stirring for 30 minutes.

Then, 40 g of an aqueous solution of hydrochloric acid (5% w/w) and 40 g of 1,3-bis(trifluoromethyl)benzene were charged into the flask. The lower fluorinated phase was separated and dried by distillation under reduced pressure (T=80° C., P=2 Pa). The obtained residue was filtered through a 0.2 μm PTFE membrane leaving 117.0 g of polymer P having the following formula: CF₃O(CF₂CF₂O)ₚ(CF₂O)_{q}CF₂—CH₂CH₂CH═CH₂. The chemical structure was confirmed by ¹⁹F-NMR and ¹H-NMR analyses.

### Example 2 (Comparative)—Synthesis of Polymer C having the Following Formula

CF₃O(CF₂CF₂O)ₚ(CF₂O)_{q}CF₂—CH₂OCH₂CH═CH₂

200 g of ZMF 402 PFPE of formula CF₃O(CF₂CF₂O)ₚ(CF₂O)_{q}CF₂CH₂OH (p/q=1.0, F=1.07, EW=4570, 44 meq), 100 g of 1,3-bis(trifluoromethyl) benzene and 53 g of a 12% w/w solution of potassium tert-butoxide in tert-butanol were charged into a 500-ml round bottom flask equipped with a mechanical stirrer, an additional funnel, a thermometer and a refrigeration column. The reaction mixture was heated up to 50° C. and let under stirring for 5 hours.

Then, the temperature was raised up to 80° C. and 9.6 g of allyl iodide (57 me) were added. The reaction mixture was then kept under stirring at this temperature for 5 hours until the signals of the pre-terminal —CF₂ group shifted from −81.3 and −83.3 ppm (when linked to —CH₂OH) to −78.2 and −80.1 ppm (when linked to —CH₂OCH₂CH═CH₂). Said shifting was monitored by ¹⁹F-NMR analysis. The reaction mixture was cooled to 20° C., added with 80 g of an aqueous solution of hydrochloric acid (5% w/w) and 40 g of 2-methyl-1-propanol and let under stirring for 30 minutes. The lower fluorinated phase was separated and the solvents were removed by distillation under reduced pressure (T=80° C., P=2 Pa). The PFPE-Intermediate B having the following formula CF₃O(CF₂CF₂O)ₚ(CF₂O)_{q}CF₂—CH₂OCH₂CH═CH₂ was recovered in an amount of 195 g. The chemical structure was confirmed by ¹⁹F-NMR and ¹H-NMR analyses.

### Stability Tests

Polymers P and C, prepared according to the Examples 1 and 2 above, were submitted to thermal stability tests in neutral and basic conditions according to the above described procedures.

The percentage of degraded product in neutral conditions was 18, 29, 36% respectively after 8, 16, 24 hours in the case of Polymer C, while no degraded product was observed in the case of Polymer P.

The percentage of degraded product in basic conditions was 8, 14, 18% respectively after 8, 16, 24 hours in the case of Polymer C, while no degraded product was observed in the case of Polymer P.

1-15. (canceled)

16. A polymer [polymer (P)] having formula (1a) or (1b):
B-R_{f}—(CFX^{F})ₘ—(CR^{H1}R^{H2})ₙ-A (1a)
A-(CR^{H1}R^{H2})ₙ—R_{f}—(CFX^{F})ₘ—(CR^{H1}R^{H2})ₙ-A (1b)
wherein:
A is a hydrocarbon group comprising an ethylenically unsaturated double bond;
B is a group of formula Y—CF₂—O—, wherein Y is selected from the group consisting of F, Cl, and a C₁-C₃ perfluoroalkyl group;
m is an integer different from zero;
n is an integer different from zero;
each of X^{F}, equal to or different from each other at each occurrence, is independently selected from the group consisting of F and a C₁-C₃ perfluoroalkyl group;
each of R^{H1} and R^{H2}, equal to or different from each other at each occurrence, is independently selected from the group consisting of H and a C₁-C₃ fluorine-free alkyl group;
R_{f} is a fluoropolyoxyalkylene chain [chain (R_{f})].

17. The polymer according to claim 16, wherein A is a group of formula:
—(CR^{H3}R^{H4})ₙₐ—CR^{H5}═CR^{H6}R^{H7}
wherein:
each of R^{H3}, R^{H4}, R^{H5}, R^{H6}, and R^{H7}, equal to or different from each other at each occurrence, is independently selected from the group consisting of H and a C₁-C₃ fluorine-free alkyl group and
na is an integer ≥0.

18. The polymer according to claim 16, wherein:
R_{f} comprises repeating units, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)_{J}—CFZ—O— wherein j is an integer from 0 to 3 and Z is a group of general formula —O—R_{(f-a)}—T, wherein R_{(f-a)} is a fluoropolyoxyalkylene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

19. The polymer according to claim 18, wherein R_{f} complies with the following formula:
—[(CFX¹O)_{g1}(CFX²CFX³O)_{g2}(CF₂CF₂CF₂O)_{g3}(CF₂CF₂CF₂CF₂O)_{g4}]—
wherein
—Xⁱ is independently selected from —F and —CF₃,
—X², X³, equal or different from each other and at each occurrence, are independently —F,
—CF₃, with the proviso that at least one of X is —F;
g1, g2 , g3, and g4, equal or different from each other, are independently integers ≥0, such that g1+g2+g3+g4 is in the range from 2 to 300 and at least two of g1, g2, g3 and g4 be different from zero.

20. The polymer according to claim 19, wherein R_{f} complies with the following formula:
—[(CF₂CF₂O)ₐ₁(CF₂O)ₐ₂]—
wherein a1 and a2 are integers >0 such that the number average molecular weight is between 400 and 10,000 and the a1/a2 ratio ranges from 0.1 to 10.

21. A process for the manufacture of polymer (P) according claim 16, said process comprising reacting a PFPE-halide of formula (2a) or (2b):
B-R_{f}—(CFX^{F})ₘ—(CR^{H1}R^{H2})ₙ-Ha¹ (2a)
Ha¹-(CR^{H1}R^{H2})ₙ—R_{f}—(CFX^{F})ₘ—(CR^{H1}R^{H2})ₙ-Ha¹ (2a)
with a Grignard reagent of formula A-MgHa²,
wherein:
A is a hydrocarbon group comprising an ethylenically unsaturated double bond;
Ha^{l} is a halogen;
Ha² is a halogen chosen among bromine, iodine and chlorine;
B is a group of formula Y—CF₂—O—, wherein Y is selected from the group consisting of F, Cl, and a C₁—C₃ perfluoroalkyl group;
m is an integer different from zero;
n is an integer different from zero;
each of X^{F}, equal to or different from each other at each occurrence, is independently selected from the group consisting of F and a C₁C₃ perfluoroalkyl group;
each of R^{H1} and R^{H2}, equal to or different from each other at each occurrence, is independently selected from the group consisting of H and a C₁-C₃ fluorine-free alkyl group;
R_{f} is a fluoropolyoxyalkylene chain [chain (R_{f})].

22. The process according to claim 21, wherein the Grignard reagent has formula:
Ha²Mg—(CR^{H3}R^{H4})ₙₐ—CR^{H5}═CR^{H6}R^{H7},
wherein:
each of R^{H3}, R^{H4}, R^{H5}, R^{H6}, and R^{H7}, equal to or different from each other at each occurrence, is independently selected from the group consisting of H and a C₁-C₃ fluorine-free alkyl group and
na is an integer ≥0.

23. The process according to claim 21, wherein the PFPE-halide is obtained by:
(I) reacting a PFPE-alcohol of formula (3a) or (3b):
B-R_{f}—(CFX^{F})ₘ—(CR^{H1}R^{H2})ₙ—OH (3a)
HO—(CR^{H1}R^{H2})ₙ—R_{f}—(CFX^{F})ₘ—(CR^{H1}R^{H2})ₙ—OH (3b)
wherein B, R_{f}, X^{F}, m, R^{H1}, R^{H2} and n are as defined in claim 21; with a compound [compound (O)] comprising a sulfonyl fluoride moiety, obtaining a PFPE-sulfonate, and
(II) reacting the PFPE-sulfonate obtained in step (I) above with a compound [compound (Q)] which is a source of nucleophilic halides, obtaining said PFPE-halide of formula (2a) or (2b).

24. The process according to claim 23, wherein said compound (O) is a perfluoroalkanesulfonyl fluoride.

25. The process according to claim 23, wherein said compound (Q) is lithium bromide.

26. A process for the synthesis of a (per)fluoropolyether derivative comprising reacting at least one polymer (P) of formula (1a) or (1b) according to claim 16 with at least one reactive compound possessing reactivity towards the ethylenically unsaturated double bond of the group A of polymer (P).

27. The process according to claim 26, wherein said (per)fluoropolyether derivative comprises at least one silane-containing chain end according to the following formulae (4a) and (4b):
B-R_{f}—(CFX^{F})ₘ—(CR^{H1}R^{H2})ₙ-A*-SiMₘ (4a)
M₃Si-A*-(CR^{H1}R^{H2})ₙ—R_{f}—(CFX^{F})ₘ—(CR^{H1}R^{H2})ₙ-A*-SiM₃ (4b)
and said reactive compound is HSiM₃, wherein:
A* is a hydrocarbon group and M is independently halogen or C₁₋₆-alkoxy.

28. The process according to claim 27, further comprising:
reacting the derivative of formula (4a) or (4b) with a Grignard reagent of formula Ha²-Mg—M*—CH═CH₂, wherein Ha² is a halogen chosen among bromine, iodine and chlorine and M* is a bond or a divalent organic group, and optionally with a compound of formula KₕL wherein K is a hydroxyl group, a hydrolysable group, or a hydrocarbon group, L is a group which is able to bind to K and h is an integer of 1-3, thus obtaining a compound of formula (5a) or (5b):
B-R_{f}—(CFX^{F})ₘ—(CR^{H1}R^{H2})ₙ-A*-Si(K_{3-k′})(—M*—CH═CH2(_{k′} (5a)
(H₂C═CH—M*—)_{k′}(K_{3-k′})Si-A*-(CR^{H1}R^{H2})ₙ—R_{f}—(CFX^{F})ₘ—(CR^{H1}R^{H2})ₙ-A*-Si(K_{3-k′})(—M*—CH═CH₂)_{k′} (5b)
wherein
M* is a bond or a divalent organic group;
k′ is independently 2 or 3;
reacting the compound of formula (5a) or (5b) with HSiM₃, wherein M is as defined above, and optionally with a compound of formula R¹n.L′, wherein le is a hydroxyl group or a hydrolysable group, L′ is a group which is able to bind to le and h* is an integer of 1-3, and/or with a compound of formula R²′n**L″, wherein R²′ is C₁₋₂₂-alkyl, L″ is a group which is able to bind to R² and h** is an integer of 1-3, thus obtaining a compound of formula (6a) or (6b):
B-R_{f}—(CFX^{F})ₘ—(CR^{H1}R^{H2})ₙ-A*-SiJₖK₃₋ₖ (6a)
SiJₖR₃₋ₖ-A*-(CR^{H1}R^{H2})ₙ—R_{f}—(CFX^{F})_{m—(CR}^{H1}R^{H2})ₙ-A*-SiJₖK₃₋ₖ (6b)
wherein:
k is independently 2 or 3, and
J represents, each independently at each occurrence, -J*-SiR¹_{n*}R²_{3-n*},
wherein:
J* is a divalent organic group;
R¹ represents, each independently at each occurrence, a hydroxyl group or a hydrolysable group;
R² represents, each independently at each occurrence, a C₁₋₂₂ alkyl group or J′, wherein J′ has the same definition as that of J,
n* is an integer selected from 0 to 3, and the total sum of n* is 1 or more.

29. A (per)fluoropolyether group containing-silane compound of formula (6a) or (6b):
B-R_{f}—(CFX^{F})ₘ—(CR^{H1}R^{H2})ₙ-A*-SiJₖK₃₋ₖ (6a)
SiJₖR₃₋ₖ-A*-(CR^{H1}R^{H2})ₙ—R_{f}—(CFX^{F})ₘ—(CR^{H1}R^{H2})ₙ-A*-SiJₖK₃₋ₖ (6b)
wherein:
A* is a hydrocarbon group;
B is a group of formula Y—CF₂—O—, wherein Y is selected from the group consisting of F, Cl, and a C₁-C₃ perfluoroalkyl group;
m is an integer different from zero;
n is an integer different from zero;
each of X^{F}, equal to or different from each other at each occurrence, is independently selected from the group consisting of F and a C₁-C₃ perfluoroalkyl group;
each of R^{H1} and R^{H2}, equal to or different from each other at each occurrence, is independently selected from the group consisting of H and a C₁-C₃ fluorine-free alkyl group;
R_{f} is a fluoropolyoxyalkylene chain [chain (R_{f})];
K represents, each independently at each occurrence, a hydroxyl group, a hydrolysable group, or a hydrocarbon group;
J represents, each independently at each occurrence, -J*-SiR^{l}_{n*}R²_{3-n*}, wherein:
J* is a divalent organic group;
R¹ represents, each independently at each occurrence, a hydroxyl group or a hydrolysable group;
R² represents, each independently at each occurrence, a C₁₋₂₂ alkyl group or J′, wherein J′ has the same definition as that of J,
n* is an integer selected from 0 to 3, and the total sum of n* is 1 or more;
k is independently 2 or 3.

30. The compound according to claim 29, wherein A* is a group of formula: —(CR^{H3}R^{H4})ₙₐ—CHR^{H5}CR^{H6}R^{H7}—
wherein:
each of R^{H3}, R^{H4}, R^{H5}, R^{H6}, and R^{H7}, equal to or different from each other at each occurrence, is independently selected from the group consisting of H and a C₁-C₃ fluorine-free alkyl group and
na is an integer ≥0.
